(19) United States
(12) Patent Application Publication
(10) Pub. No.: US 2026/0032319 A1
(43) Pub. Date: Jan. 29, 2026

(54) LIVE STREAMING METHOD FOR LOCAL AREA NETWORK, STORAGE MEDIUM, AND COMPUTER DEVICE

(71) Applicant: Beijing Zitiao Network Technology Co., Ltd., Beijing (CN)

(72) Inventors: Jiqin DU, Beijing (CN); Ruisheng ZHANG, Beijing (CN)

(21) Appl. No.: 19/279,256

(22) Filed: Jul. 24, 2025

(30) Foreign Application Priority Data
Jul. 25, 2024 (CN) 202411009755.8

(51) Int. Cl. H04N 21/61; H04N 21/2187; H04N 21/6338; H04N 21/6405; H04N 21/643

(52) U.S. Cl. CPC H04N 21/6125; H04N 21/2187; H04N 21/6338; H04N 21/6405; H04N 21/64322

(57) ABSTRACT

A live streaming method for a local area network, a storage medium, and a computer device are provided. The live streaming method is applied to a live streaming system for a local area network, the live streaming system for a local area network includes a live streaming terminal, a target media server and a client that access the local area network. The method includes: a live streaming terminal accessing a local area network; determining, by the live streaming terminal, a target media server that accesses the local area network based on a multicast protocol mechanism or an address resolution protocol scanning mechanism; acquiring, by the live streaming terminal, a live streaming room number of the target media server; and pushing, by the live streaming terminal, a live streaming content to a client connecting to the live streaming room number by using the target media server.

### CROSS-REFERENCE TO RELATED APPLICATION

This application claims the priority to and benefits of the Chinese Patent Application, No. 202411009755.8, which was filed on Jul. 25, 2024, which is hereby incorporated by reference in its entirety.

### TECHNICAL FIELD

The present application relates to the field of computer technology, and in particular, to a live streaming method for a local area network, a storage medium, and a computer device.

### BACKGROUND

With the rapid development of virtual reality (VR) technology, VR live streaming has gradually become an important application in the fields of education, entertainment and enterprise training, etc. The VR live streaming may be divided into live streaming for a wide area network and live streaming for a local area network. The live streaming for a wide area network is mainly targeted to terminal consumers, and typical application scenarios include live streaming of sports events, game live streaming, touring live streaming, and the like. The live streaming for a local area network is mainly targeted to colleges and universities, enterprise customers, and the like, and has been widely applied to the fields of education, training, enterprise meetings, etc. It realizes real-time transmission and sharing of VR content for the local area network, and has the advantages of convenient deployment, low cost, and the like. However, the existing technology has some key technical problems, such as complicated configuration of a media server, unreliable discovery mechanism and server conflict. These problems have serious impacts on the deployment efficiency and stability of live streaming for a local area network.

### SUMMARY

Embodiments of the present application provide a live streaming method for a local area network, a storage medium, and a computer device that can improve the deployment efficiency and stability of live streaming.

In one aspect, the embodiments of the present application provide a live streaming method for a local area network, wherein the live streaming method is applied to a live streaming system for a local area network, the live streaming system for a local area network comprises a live streaming terminal, a target media server and a client that access the local area network; wherein the method comprises:
a live streaming terminal accessing a local area network;
determining, by the live streaming terminal, a target media server that accesses the local area network based on a multicast protocol mechanism or an address resolution protocol scanning mechanism;
acquiring, by the live streaming terminal, a live streaming room number of the target media server; and
pushing, by the live streaming terminal, a live streaming content to a client connecting to the live streaming room number by using the target media server.

In another aspect, the embodiments of the present application provide a non-volatile computer-readable storage medium, which stores a computer program adapted to be loaded by a processor to perform the live streaming method for a local area network according to any one of the afore-mentioned embodiments.

In still another aspect, the embodiments of the present application provide a computer device, which comprises a memory having a computer program stored thereon, and a processor configured to execute the computer program in the memory to implement the live streaming method for a local area network according to any one of the afore-mentioned embodiments.

The embodiments of the present application are applied to the live streaming system for a local area network. The live streaming system for a local area network includes the live streaming terminal, the target media server and the client that access the local area network. The live streaming terminal accesses the local area network; the live streaming terminal determines the target media server that accesses the local area network based on the multicast protocol mechanism or the address resolution protocol scanning mechanism; the live streaming terminal acquires the live streaming room number of the target media server; and the live streaming terminal pushes the live streaming content to the client connecting to the live streaming room number by using the target media server. The embodiments of the present application introduce the multicast protocol (e.g., mDNS) or the address resolution protocol (ARP) scanning mechanism, so that the live streaming terminal can automatically discover and identify the target media server within the local area network. The double mechanisms not only make the discovery of the target media server more intelligent and automatic, but also greatly increase the discovery probability of the target media server in a complex network environment. Such a design of double mechanisms enables the system to adapt to more types of network environments. The target media server can be found through a suitable mechanism even in an environment where the network multicast function is limited, and then a live streaming connection is established. The process of automatically discovering and connecting the target media server greatly simplifies the deployment flow of the live streaming system for a local area network, thereby improving the deployment efficiency. Meanwhile, because the system can establish the live streaming connection more stably, the problems of stream interruption, lags and the like in the live streaming process are effectively mitigated, and the stability of live streaming and the user experience are further improved.

### BRIEF DESCRIPTION OF DRAWINGS

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

FIG. 1 is a structural schematic diagram of a live streaming system for a local area network provided by an embodiment of the present application;

FIG. 2 is a flowchart of a live streaming method for a local area network provided by an embodiment of the present application;

FIG. 3 is a schematic diagram of a first application scenario of a live streaming method for a local area network provided by an embodiment of the present application;

FIG. 4 is a schematic diagram of a second application scenario of a live streaming method for a local area network provided by an embodiment of the present application; and

FIG. 5 is a structural schematic diagram of a live streaming terminal provided by an embodiment of the present application.

### DETAILED DESCRIPTION

The technical solutions in the embodiments of the present application will be described clearly and completely below with reference to the accompanying drawings in the embodiments of the present application. Apparently, the described embodiments are merely some rather than all of the embodiments of the present application. All other embodiments derived from the embodiments of the present application by a person of ordinary skill in the art without creative efforts should fall within the protection scope of the present application.

The embodiments of the present application provide a live streaming method for a local area network, a storage medium, and a computer device. In particular, the live streaming method for a local area network provided by the embodiments of the present application may be performed by a terminal device or a server. The computer device may be a terminal device or a server. The terminal device may be a smart phone, a tablet computer, a laptop computer, a desktop computer, a smart TV, a smart speaker, a wearable smart device, an intelligent vehicle terminal, a virtual reality device, and the like. The terminal device may further include a client which may be a client of an application program capable of carrying out live streaming for a local area network. For example, the client includes at least one of a program client and a web client. For example, the application program may be a social application program, a chatting robot application program, a customer service application program, etc. For example, the application program may also be other application programs that have the chatting functions, such as reading, shopping, video, music, game, financial management, and office application programs having the chatting function. The server may be an independent physical server, a server cluster or a distributed system composed of a plurality of physical servers, or a cloud server that provides basic cloud computing services, such as a cloud service, a cloud database, cloud computing, a cloud function, cloud storage, a network service, cloud communication, a middleware service, a domain name service, a security service, a content delivery network (CDN), big data and artificial intelligence platforms.

The embodiments of the present application may be applied to various application scenarios such as video making and video auditing.

With reference to FIG. 1, FIG. 1 is a structural schematic diagram of a live streaming system for a local area network provided by an embodiment of the present application. The live streaming system for a local area network includes a live streaming terminal 10, a target media server 20 and a client 30 that access the local area network 40.

The live streaming terminal 10 is configured to push the acquired live streaming content (e.g., an audio and video stream, a text message, etc.) to the target media server 20. A workstation with strong performance is usually used as a live streaming host of the live streaming terminal 10, for example, a personal computer (PC) and a live streaming application program (App) mainly configured to run live streaming control software, and control, by using the live streaming control software, the client 30 (e.g., a Virtual Reality device, namely VR device) that accesses the local area network 40, and distribute, by using a media server, a live streaming content generated during the live streaming of a live streamer to the client 30 that accesses the local area network 40. The live streaming App is the source of the live streaming content, and the content may be in the form of two-dimensional (2D), three-dimensional (3D), or panoramic. The connection between the live streaming App and the live streaming control software may be in direct data exchange, or may be achieved by a third-party platform (e.g., a virtual reality experiencing platform). For example, the live streaming control software may be VR live streaming control software.

The target media server 20 may run on an independent server or the live streaming host. The target media server 20 is mainly responsible for transmitting the live streaming content within the local area network 40. By virtue of an efficient audio and video encoding algorithm of the target media server 20, the live streaming content pushed by the live streaming terminal 10 may be distributed to tens of, even hundreds of the clients 30 (e.g., a VR devices).

The client 30 is a live streaming watching terminal. The client (e.g., a VR device) usually running the live streaming control software is configured to receive the live streaming content forwarded by the target media server 20 for a viewer to watch the live streaming content on the client 30.

The target media server 20 is a distribution center of the live streaming content. The live streaming terminal 10 and the client 30 can discover each other after they connect to the target media server 20 and join in the same live streaming room, and then, the live streaming terminal 10 and the client 30 can complete subsequent activities, such as live streaming and communication.

The live streaming system for a local area network 40 provided in the embodiments of the present application introduces the multicast protocol (e.g., mDNS) and the address resolution protocol (ARP) scanning mechanism, so that the live streaming terminal 10 can automatically discover and identify the target media server 20 within the local area network 40. The double mechanisms not only make the discovery of the target media server 20 more intelligent and automatic, but also greatly increase the discovery probability of the target media server 20 in a complex network environment. Such a design of double mechanisms enables the system to adapt to more types of network environments. The target media server 20 can be found through a suitable mechanism even in an environment where the network multicast function is limited, and then a live streaming connection is established. The process of automatically discovering and connecting the target media server 20 greatly simplifies the deployment flow of the live streaming system for the local area network 40, thereby improving the deployment efficiency. Meanwhile, because the system can establish the live streaming connection more stably, the problems of stream interruption, lags and the like in the live streaming process are effectively mitigated, and the stability of live streaming and the user experience are further improved.

The live streaming terminal 10 and the client 30 may be terminal devices. The terminal device may be a smart phone, a tablet computer, a laptop computer, a desktop computer, a smart TV, a smart speaker, a wearable smart device, an intelligent vehicle terminal, a virtual reality device, and the like. The target media server 20 may be a server which may be an independent physical server, a server cluster or a distributed system composed of a plurality of physical servers, or a cloud server providing basic cloud computing services, such as a cloud service, a cloud database, cloud computing, a cloud function, cloud storage, a network service, cloud communication, a middleware service, a domain name service, a security service, a content delivery network (CDN), and big data and artificial intelligence platforms.

Details are described below. It needs to be noted that the order of describing the following embodiments is not defined as a preferred order of the embodiments.

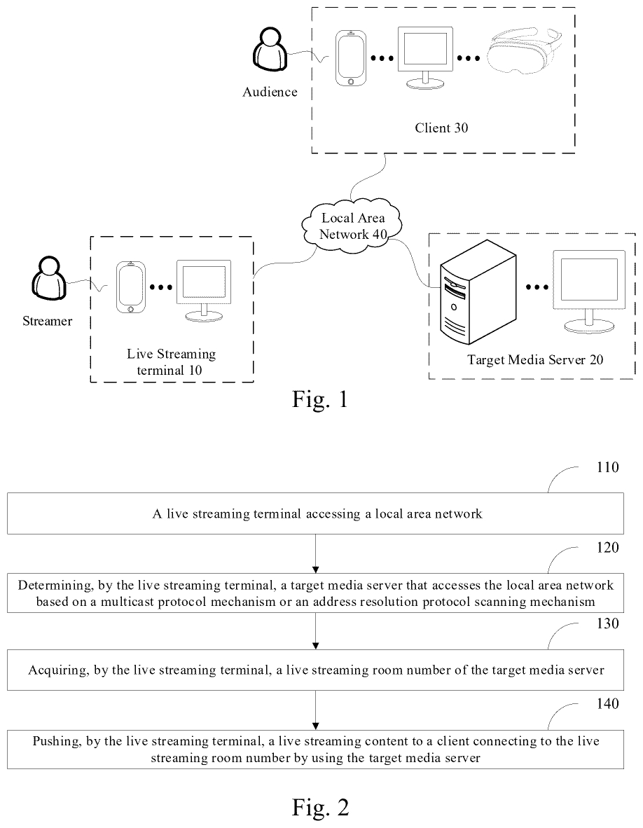

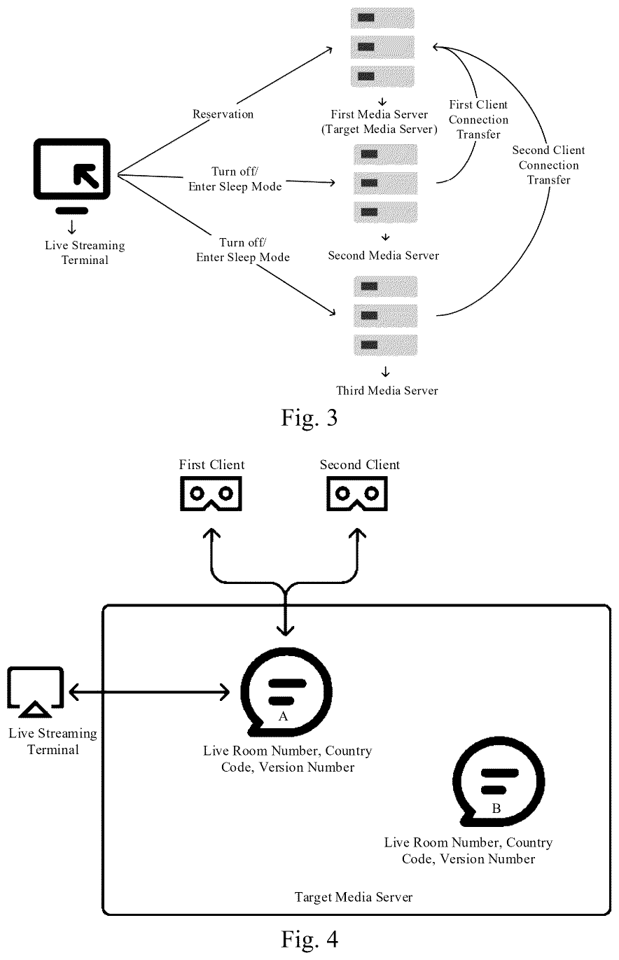

With reference to FIG. 2 to FIG. 4. FIG. 2 is a flowchart of a live streaming method for a local area network provided by an embodiment of the present application, and FIG. 3 and FIG. 4 are schematic diagrams of application scenarios of a live streaming method for a local area network provided by embodiments of the present application. The method is applied to a live streaming system for a local area network, and the live streaming system for a local area network includes a live streaming terminal, a target media server and a client that access the local area network. The method can be applied to the live streaming terminal 10 shown in FIG. 1. The method includes the following step 110 to step 140.

In step 110, a live streaming terminal accesses a local area network.

In the live streaming system for a local area network, the live streaming terminal is a device that initiates live streaming, such as a camera, a smart phone, or a computer. When the device performs live streaming, the live streaming terminal may connect to a local network through an Ethernet cable or in other local area network connection manners, to become an active node in the local area network. The process of accessing the local area network usually involves setting network parameters for the device, such as an IP address, a subnet mask, a gateway and the like, ensuring that the device can communicate with other devices within the local area network. After accessing successfully, the live streaming stream will be in a standby state to wait for a subsequent live streaming operation instruction.

In some embodiments, after the live streaming terminal accesses the local area network, the method further includes:
detecting whether a plurality of media servers are present within the local area network;
in response to detecting that the plurality of media servers are present within the local area network, determining one of the plurality of media servers as the target media server; and
controlling, by using a second server interface, other media servers to be turned off or controlling other media servers to enter a sleep state.

In some embodiments, the method further includes:
In response to detecting that no media server is present within the local area network, determining, by the live streaming terminal, the target media server that accesses the local area network based on the multicast protocol mechanism or the address resolution protocol scanning mechanism.

For example, the VR live streaming for a local area network is used as an example. In the process of VR live streaming for the local area network, the most common reason for failure to live streaming deployment is: there are two or more media servers access the local area network due to the negligence of a user. This problem may be highly concealed. Firstly, the media servers are unaware of the presence of each other. Secondly, the media servers within the local area network may not interfere with each other and may normally work at the same time. This might result in the live streaming terminal (e.g., a PC device) and the client (e.g., a VR device) of the VR live streaming control software accessing different media servers respectively without knowing each other's situation. That is, the live streaming terminal (e.g., a PC device) and the client (e.g., a VR device) of the VR live streaming control software have accessed the same local area network, but cannot establish communication.

In order to solve this problem, firstly, at the beginning of live streaming, the media servers within the same local area network are enabled to perceive the presence of other media servers. In particular, after one media server accesses the local area network, multicast protocol (mDNS) broadcasting is not enabled first, and instead, the VR live streaming control software detects whether a plurality of media servers are present within the local area network. If no more media server is detected, it proves that there is no other media server within the local area network. In this case, the subsequent step 120 can be performed, for example, the mDNS broadcasting is normally started, so as to provide services for the live streaming terminal (e.g., a PC device) and the client (e.g., a VR device) of the VR live streaming control software within the local area network. On the contrary, if a plurality of media servers present within the local area network are detected, one of the plurality of media servers is determined as the target media server, and other media servers besides the target media server cannot provide service. By using a second service interface, the other media servers may be controlled to be turned off, or the other media servers may be controlled to enter a sleep state, ensuring the uniqueness of the media server within the local area network.

In actual deployment, due to network delay, it is possible that a media server accessing later may not be detected, despite a media server already being present within the local area network, and consequently, a plurality of active media servers are present within the local area network. In order to cope with this possible case, a media server running control function may be added to the live streaming terminal (e.g., a PC device) of the VR live streaming control software. In particular, after the live streaming terminal (e.g., a PC device) of the VR live streaming control software accesses the local area network, if no client (e.g., a VR device) is found, a long-time deep searching can be carried out by using the live streaming terminal (e.g., a PC device) of the VR live streaming control software, in order to find the IP addresses of all media servers within the local area network as much as possible and return them to the user in the form of a list. Meanwhile, the second service interface is opened on the media server. For example, the second service interface is a web service interface, which may be denoted as closeService( ) and configured to control the startup and sleep of the media server from the outside.

As shown in FIG. 3, the live streaming terminal (e.g., a PC device) of the VR live streaming control software discovers a plurality of media servers, for example, a first media server, a second media server, and a third media server. The live streaming terminal may select one of them as the target media server, for example, select to retain the first media server; and the other media servers are controlled to be turned off, or other media servers are controlled to enter the sleep state. For example, the second media server and the third media server are controlled to be turned off or to enter the sleep state. These media servers turned off or entering the sleep state disconnects the clients (e.g., the first client and the second client) that has been connected. Thus, these clients are forced to search for the media server again so as to access the first media server retained by the live streaming terminal of the VR live streaming control software, as a result, the live streaming terminal and the clients (e.g., the first client and the second client) of the VR live streaming control software can establish correct connections.

In step 120, the live streaming terminal determines a target media server that accesses the local area network based on a multicast protocol mechanism or an address resolution protocol scanning mechanism.

In the local area network, the target media server is a device for processing the live streaming content; the target media server receives the live streaming content pushed by the live streaming terminal and distributes it to the client that connects to a live streaming room number. In order to find the target media server, the live streaming terminal can use two mechanisms for scanning;

Multicast protocol mechanism (e.g., mDNS): the multicast protocol allows the live streaming terminal to send a multicast query message to all media servers within the local area network with no need to know the specific address of the target media server. The live streaming terminal may send a multicast query message containing a specific identifier. The target media server may respond and feed back a first response message after receiving the multicast query message, and thus, the target media server can be discovered by the live streaming terminal. This manner is suitable for a network environment that supports the multicast function.

Address resolution protocol (e.g., ARP) scanning mechanism: if the network does not support the multicast function, the live streaming terminal may discover the target media server using the ARP scanning mechanism. The ARP is a transmission control protocol/internet protocol (TCP/IP protocol) for acquiring a media access control (MAC) address according to an internet protocol (IP) address, which is configured to convert the IP address to the MAC address. The live streaming terminal may send an ARP scanning request to query the MAC addresses of all active media servers within the local area network. After receiving the ARP scanning request, the media server replies the request, thus exposing its presence. The live streaming terminal can determine the IP address and the MAC address of the media server by parsing the ARP reply.

By using the two mechanisms, the live streaming terminal can automatically discover the media servers within the local area network to lay a foundation for subsequent connection and live streaming operations.

In some embodiments, the determining, by the live streaming terminal, a target media server that accesses the local area network based on a multicast protocol mechanism or an address resolution protocol scanning mechanism includes:
detecting whether the local area network supports the multicast protocol mechanism;
in response to that the local area network supports the multicast protocol mechanism, determining, by the live streaming terminal, the target media server that accesses the local area network based on the multicast protocol mechanism; or
in response to that the local area network does not support the multicast protocol mechanism, determining, by the live streaming terminal, the target media server that accesses the local area network based on the address resolution protocol scanning mechanism.

For example, taking VR live streaming for the local area network as an example, before the VR live streaming for the local area network begins, the live streaming terminal (e.g., a PC device) and the client (e.g., a VR device) of the VR live streaming control software firstly discover the target media server by using the multicast protocol mechanism (e.g., mDNS), and then establish a session within the target media server, so that the subsequent communication can be realized. In actual deployment, some users may disable the multicast protocol mechanism within the local area network based on security consideration. This directly results in that the live streaming terminal (e.g., a PC device) and the client (e.g., a VR device) of the VR live streaming control software cannot establish connection. In order to solve this problem, the live streaming terminal (e.g., a PC device) and the client (e.g., a VR device) of the VR live streaming control software may, after accessing the local area network, firstly carry out a multicast test to detect whether the local area network supports the multicast protocol mechanism. In response to that the local area network supports the multicast protocol mechanism, the multicast protocol mechanism can be used to discover the target media server that accesses the local area network, and in response to that the local area network doesn't support the multicast protocol mechanism, the address resolution protocol (ARP) scanning mechanism can be used to discover the target media server that accesses the local area network.

In some embodiments, the detecting whether the local area network supports the multicast protocol mechanism includes:
within a test time window, sending a test data package to a target multicast address and a target port number within the local area network at a preset frequency;
in response to that a response data package corresponding to the test data is received before the test time window ends, determining that the local area network supports the multicast protocol mechanism; or
in response to that no response data package corresponding to the test data is received after the test time window ends, determining that the local area network does not support the multicast protocol mechanism.

For example, the method for detecting the multicast is specifically as follows: within the test time window (e.g., 10 seconds), the test data package is continuously sent at a preset frequency to a target multicast address (e.g., management permission multicast address 239.0.1.2) and a target port number (e.g., specific port 2345): meanwhile, the monitoring on the target multicast address and the target port number is started. In response to that a response data package corresponding to the test data is received before the test time window ends, it is determined that the local area network supports the multicast protocol mechanism, and the multicast protocol mechanism (e.g., mDNS) can be used to discover the target media server that accesses the local area network. On the contrary, in response to that no response data package corresponding to the test data is received after the test time window ends, it is determined that the local area network does not support the multicast protocol mechanism, which proves that the multicast protocol mechanism is unavailable, and a second search mechanism, the address resolution protocol (ARP) scanning mechanism, is used to discover the target media server that accesses the local area network.

In some embodiments, the determining, by the live streaming terminal, the target media server that accesses the local area network based on the multicast protocol mechanism includes:
sending, by the live streaming terminal, a multicast query message to the local area network;
receiving, by the live streaming terminal, a first response message corresponding to the multicast query message, wherein the first response message includes identification information of the target media server; and
determining the target media server that accesses the local area network based on the first response message.

In some embodiments, the identification information includes an internet protocol (IP) address; and the determining the target media server that accesses the local area network based on the first response message includes:
determining the target media server that accesses the local area network based on the IP address of the target media server carried by the first response message.

When the live streaming terminal is started and is ready for accessing the local area network, it may firstly check whether the local area network supports the multicast protocol (e.g., mDNS, SSDP, etc.) mechanism. Once it is confirmed that the local area network supports the multicast protocol, the live streaming terminal may generate a multicast query message. The multicast query message usually contains a query request to a specific service type (e.g., a media server service) and relevant information (e.g., the IP address or the port number of the live streaming terminal) of a sender. The live streaming terminal may then send the multicast query message to a target multicast address within the local area network. The target multicast address is reserved for multicast communication, and all devices that monitor the target multicast address can receive the multicast query message.

The media server within the local area network monitors messages on the target multicast address. Upon receiving the multicast query message sent by the live streaming terminal, the media server within the local area network may check whether the media server itself provides a queried service type (i.e., the media server service) or not. If it is yes, the media server may respond to the multicast query information and generate a first response message, and send the first response message to the live streaming terminal. The first response message contains the identification information of the media server, so that the live streaming terminal can identify the identification information and establish a connection with the media server.

After receiving the first response message, the live streaming terminal parses the first response message to obtain the identification information of the media server and determine which media server can provide the desired service according to the identification information contained in the message. This process may be based on a plurality of types of identification information, such as an IP address, a media access control (MAC) address, a server name, a service type, and the like.

In certain embodiments, the identification information contained in the first response message may be the internet protocol (IP) address of the target media server. The IP address is a digital signature for uniquely identifying a network device in network communication. The live streaming terminal may determine the target media server that accesses the local area network based on the IP address. For example, the live streaming terminal might store the IP address into an internal memory as a target address for subsequent communication with the target media server.

After determining the IP address of the target media server, the live streaming terminal establishes a network connection with the target media server using the IP address. This usually involves initiating a connection request of a transmission control protocol (TCP) or a user datagram protocol (UDP) (particularly depending on the protocol supported by the media server), and sending necessary authentication information, configuration parameters and the like after the connection is established, so that both parties can start normal data transmission. If the TCP is used, the live streaming terminal will initiate a TCP handshaking process; and if the UDP is used, the live streaming terminal directly starts data transmission.

Such a multicast protocol mechanism may be applied to a plurality of scenarios, such as live streaming within an enterprise, remote education, or online meetings, thus the live streaming content can be distributed efficiently within the local area network.

In some embodiments, the determining, by the live streaming terminal, the target media server that accesses the local area network based on the address resolution protocol scanning mechanism includes:
determining, by the live streaming terminal, an active media server based on the address resolution protocol scanning mechanism;
sending, by the live streaming terminal, a state query message to the active media server; and
receiving, by the live streaming terminal, a second response message fed back by the active media server in response to the state query message, and determining the target media server.

In some embodiments, the determining, by the live streaming terminal, an active media server based on the address resolution protocol scanning mechanism includes:
sending, by the live streaming terminal, a scanning request that contains a target address range into the local area network, so as to request for scanning media access control (MAC) addresses of all active media servers within the target address range; and
determining IP addresses of all the active media servers within the local area network, according to the received MAC addresses fed back from all the active media servers within the local area network in response to the scanning request.

In some embodiments, the sending, by the live streaming terminal, a state query message to the active media server includes:
sending, by the live streaming terminal, the state query message to a first service interface of each of the active media servers based on the IP address of each of the active media servers, wherein the first service interface is configured to query a working state of the active media server.

In some embodiments, the receiving, by the live streaming terminal, a second response message fed back by the active media server in response to the state query message, and determining the target media server, includes:
parsing, by the live streaming terminal, a content of the second response message, and determining a media server as a candidate media server, wherein the media server, in response to the state query message, determines the working state as a normal working state based on the second response message:
parsing, by the live streaming terminal, the content of the second response message to determine whether the live streaming terminal, the candidate media server and the client match; and
in response to that the live streaming terminal, the candidate media server and the client match, determining the candidate media server as the target media server.

The live streaming terminal determines the active media server based on the ARP scanning mechanism.

For example, the live streaming terminal may firstly establish an ARP scanning request which contains a target address range (e.g., 192.168.1.1 to 192.168.1.255), and send the ARP scanning request as a broadcast message to all devices within the local area network. The ARP scanning request is used for querying which device, within the local area network, possesses an IP address within the target address range and requesting the MAC addresses of these devices.

Then, after receiving the ARP scanning request, devices (including media servers) within the local area network may check whether the IP address within the target address range in the ARP scanning request matches their own IP address. If there is a match, the device sends an ARP response message that contains its MAC address to the live streaming terminal. By collecting these ARP response messages, the live streaming terminal may establish a list containing the MAC addresses of all active devices within the local area network, e.g., an IP-MAC mapping table.

IP address resolution: because the ARP response only contains the MAC address, the live streaming terminal may utilize some additional mechanisms (such as the IP-MAC mapping table) to convert the MAC address to the corresponding IP address, thereby determining which devices are media servers.

Then, the live streaming terminal sends the state query message to the active media server. By the above process, the live streaming terminal has acknowledged IP addresses of all possible active media servers within the local area network. Next, the live streaming terminal may send the state query message to the first service interface of each of the media servers based on the IP address of each of the media servers. The state query message usually is an HTTP request for requesting the media server to return its current working state information.

The live streaming terminal then receives the second response message fed back by the active media server in response to the state query message and determines the target media server.

For example, after receiving the state query request, the media server may generate the corresponding second response message according to the state query message and return the corresponding second response message to the live streaming terminal through HTTP response. The live streaming terminal may parse the content of the second response message. In the parsing process, the live streaming terminal may check whether the working state of the media server is “normal”, and meanwhile, may also verify whether the response contains other necessary state information (such as a load condition and availability of resources). If the state is normal, the media servers of which the working states are normal are regarded as candidate media servers.

After determining the candidate media servers, the live streaming terminal may further perform a series of match inspections to ensure that the selected candidate media server can meet the requirements of the live streaming terminal and the client. These inspections may include network delay test, bandwidth evaluation, compatibility verification, etc.

By comprehensively evaluating the state information and match of all the candidate media servers, the live streaming terminal may finally select an optimal media server as the target media server. The target media server is responsible for transmission and processing tasks of the live streaming data.

For example, taking a VR live streaming for a local area network as an example, the live streaming terminal broadcasts the ARP scanning request that contains the target address range to all hosts within the local area network and receives return messages, thereby determine the MAC address of the target media server. In this way, the IP addresses of the active media servers within the local area network may be acquired by an enumeration method. This is referred to as ARP scanning. However, it is not enough to only find the IP addresses of the active media servers within the local area network. In order to determine whether the scanned active media server is the target media server, the media servers are required to cooperate for determination. To this end, the first service interface can be enabled on the media server. For example, the first service interface is web service interface, which may be denoted as query Status( ) and is specifically used for querying the working state of the media server. Only the hosts that make responses to the state query message (e.g., HTTP request) are the candidate media servers. Moreover, considering that the service of the media server might be abnormal due to some reasons, such as a service conflict or the compatibility of operating systems, the live streaming terminal and the client of the VR live streaming control software may further parse the responding content (the second response message). Only the media server that works normally and is selected as the selected candidate media server can meet the requirements of both the live streaming terminal and the client, and can serve as the target media server that accesses the local area network.

In practical application, the security problem also needs to be considered. For example, upon receiving a response message (such as the first response message or the second response message), the live streaming terminal should verify whether the source of the response message is credible to prevent a malicious device from pretending to be a media server to respond. Moreover, after a connection is established, suitable safety measures should further be taken to protect the security, integrity and availability in the data transmission process.

For example, the credibility of the source of the response message can be verified with a digital signature. The live streaming terminal may require the media server to include a digital signature in the response message. The digital signature is generated by the media server encrypting the first response message (or a digest thereof) with a private key thereof. After receiving the first response message, the live streaming terminal may verify the signature using a public key of the media server. If the signature is valid, it indicates that the first response message is indeed from the media server possessing the corresponding private key, thus verifying the credibility of the source of the response message.

For example, the credibility of the source of the response message can be verified with a certificate. In a more complex scenario, the media server may possess a secure socket layer or a transport layer security (SSL/TLS) certificate issued by a trusted certification authority (CA). Before establishing a connection, the live streaming terminal may require the media server to provide its certificate and confirm the identity of the media server by verifying the integrity and validity of a certificate chain. This includes checking whether the certificate is issued by the trusted CA, whether the certificate has expired, whether a domain name in the certificate matches a domain name of the media server, etc.

For example, the security in the data transmission process can be ensured by encrypting communication. The communication between the live streaming terminal and the media server should be carried out through an encryption protocol, such as the secure socket layer/transport layer security (SSL/TLS) protocols. These protocols can ensure that the transmitted live streaming content data is encrypted on the network. Thus, even though the data is intercepted, it cannot be decrypted easily by an unauthorized party. Moreover, the SSL/TLS protocols can further provide the function of authentication to ensure that the identities of both parties of communication are credible.

For example, data integrity verification may be further carried out. In order to prevent the live streaming content data from being tampered in the transmission process, the live streaming terminal and the target media server may verify the integrity of the live streaming content data using message authentication codes (MACs) or a hash function in the communication process. Before sending the live streaming content data, the live streaming terminal may calculate a hash value or MACs of the live streaming content data, and send the hash value or MACs, together with the live streaming content data, to a receiver. After receiving the live streaming content data, the target media server may recalculate a hash value or MACs of the live streaming content data, and compare the recalculated hash value or MACs with the received hash value or MACs. If the two are consistent, it indicates that the live streaming content data is not tampered in the transmission process.

For example, access control and permission management may be further carried out between the live streaming terminal and the target media server. Only the authorized live streaming terminal can access resources on the target media server. This may be achieved by configuring an access control list (ACL) on the target media server or using authentication and authorization mechanisms. Meanwhile, the media server should be able to record and audit all access attempts, so as to trace and investigate when security incidents occur.

For example, the live streaming terminal and the target media server may also regularly update their software versions and patches to repair known security vulnerabilities and defects. This includes updating of all relevant components such as an operating system, a network protocol stack, and an encrypt library. Meanwhile, close attention should be paid to security advisories and vulnerability information in order to respond rapidly and take a corresponding security measure when a new vulnerability is discovered.

In step 130, the live streaming terminal obtains a live streaming room number of the target media server.

This step involves acquiring, by the live streaming terminal, a unique room number for current live streaming from the determined target media server. The live streaming room number is an identifier to be used by the live streaming terminal and the client when the join in a live streaming session. It allows the live streaming terminal to accurately distribute a video stream to all clients requesting to join in the specific live streaming room. The room number is usually distributed by the media server and might contain information about a live streaming content, a time, a format, etc.

The live streaming room number is a unique identifier for the target media server to identify different live streaming contents. The live streaming room number is an identifier to be used by the live streaming terminal and the client when they join in a live streaming session. It allows the live streaming terminal to accurately distribute a video stream to all clients requesting to join in the specific live streaming room. After discovering the target media server, the live streaming terminal obtains the live streaming room number of the target media server so as to push the live streaming content to the correct position. The live streaming room number is usually distributed by the media server at startup and may be acquired through a specific interface or protocol. The media server, when distributing the live streaming room number, may also distribute information about the time, format and the like of the live streaming content.

In some embodiments, the first response message further includes a live streaming room number of the target media server: the live streaming room number is generated based on the identification information of the target media server; and
the acquiring, by the live streaming terminal, a live streaming room number of the target media server includes:
acquiring, by the live streaming terminal, the live streaming room number of the target media server based on the live streaming room number of the target media server carried by the first response message.

In some embodiments, the second response message further includes a live streaming room number of the target media server: the live streaming room number is generated based on the identification information of the target media server; and
the acquiring, by the live streaming terminal, a live streaming room number of the target media server includes:
acquiring, by the live streaming terminal, the live streaming room number of the target media server based on the live streaming room number of the target media server carried by the second response message.

In some embodiments, the identification information further includes a MAC address; and the live streaming room number is generated by an information digest encryption algorithm based on the MAC address of the target media server.

For example, for the traditional VR live streaming for a local area network, a fixed room number is substantially used to establish communication. Consequently, the live streaming background cannot search for a live streaming solution described by the user according to a room number provided by the user. This brings great inconvenience for user support. To this end, different room numbers are to be distributed to each live streaming for a local area network. However, due to the closed nature of the live streaming for a local area network, the room numbers cannot be distributed from the backend like the live streaming for a wide area network. Here, two problems need to be solved: the first one is how to guarantee that the room numbers generated by different local area networks are certainly different to avoid confusing by the background; and the second one is how to guarantee that the client can correctly acquire the unique room number of the current live streaming before accessing the media server.

For the first problem, the unique room number (live streaming room number) of the current live streaming may be acquired using the information digest encryption algorithm (e.g., md5 encryption algorithm) on the basis of the MAC address of the media server. Due to the global uniqueness of the MAC address, the uniqueness of the generated live streaming room number is guaranteed. The md5 encryption algorithm plays a role in guaranteeing security, preventing leakage of the MAC address of the target media server and thus avoiding the resulting network security problems.

For the second problem, because the first response message (e.g., mDNS response message) or the second response message (e.g., HTTP response message) is capable of carrying a short message, the above-mentioned generated room number information is packaged into the first response message or the second response message, such that the live streaming terminal and the client of the VR live streaming control software determine the live streaming room number used for accessing the target server while discovering the target media server, thereby correctly establishing a connection.

In step 140, the live streaming terminal pushes a live streaming content by using the target media server to a client that connects to the live streaming room number.

After acquiring the live streaming room number of the target media server, the live streaming terminal will establish a connection with the target media server and start to push the live streaming content to the target media server. The live streaming content may be multimedia data, such as an audio and video data stream, an image, a text message and the like, and the multimedia data is transmitted with specific encoding and transmission protocols. The live streaming terminal may package live streaming contents into a data package meeting a requirement of the media server, and distribute these encoded live streaming contents to all clients connecting to the same live streaming room number by using the target media server. The client is a terminal device on which the VR live streaming control software runs. The client joins in the session through the live streaming room number of the target media server; and after receiving the data package, the client may decode and render it to present the live streaming contents. This process relies on the efficient audio and video encoding and transmission algorithms of the media server, ensuring that the live streaming content can reach the client corresponding to each viewer smoothly even though tens of and even hundreds of clients (e.g., a VR devices) are online simultaneously. This process can guarantee the real-time performance and stability of data to ensure the fluency of live streaming and the user experience.

In some embodiments, before the pushing, by the live streaming terminal, a live streaming content to a client that connects to the live streaming room number by using the target media server, the method further includes:
acquiring a live streaming room number, a country code and a version number corresponding to the live streaming terminal:
acquiring a live streaming room number, a country code and a version number corresponding to the client; and
in response to that the live streaming room numbers respectively corresponding to the live streaming terminal and the client match with each other, the country codes respectively corresponding to the live streaming terminal and the client match with each other, and the version numbers respectively corresponding to the live streaming terminal and the client match with each other, pushing, by the live streaming terminal, the live streaming content to the client that connects to the live streaming room number by using the target media server.

For example, the live streaming control software involves two parts: live streaming terminal and client. The upgrade and maintenance of the two parts of software are independent of each other. It is very likely that the live streaming for a local area network is unavailable due to that versions do not match. Moreover, due to the limitations of the laws and regulations of different countries and regions, the live streaming terminal (e.g., a PC device) and the client (e.g., a VR device) of the live streaming control software have different versions which cannot be mixed to avoid compliance risks. For example, the live streaming terminal of the live streaming control software with country A's version cannot be used to connect to the client of the live streaming control software with country B's version. If the versions are checked manually, a lot of energy needs to be consumed. To this end, a detection mechanism is designed to guarantee the compatibility of the live streaming terminal and the client of the live streaming control software and the compliance of connection, and when not matching is detected, prompt information may be output to prompt the user.

Before pushing the live streaming content to the client that connects to the live room number by using the target media server, the live streaming terminal may perform a series of compatibility and compliance inspections, ensuring the compatibility and compliance between the live streaming terminal and the client.

For the compatibility problem, the live streaming terminal and the client use a unified version naming rule, usually including a major version, a minor version, and a patch version. The major version is used for ensuring the basic functional compatibility, and the minor version and the patch version are usually used for iterative updating of functions and vulnerability repair. The compatibility mainly relies on the consistency of the major versions. The live streaming terminal and the client can substantially be compatible as long as the major versions are the same, even though the minor versions and the patch versions are different.

Before establishing the connection, the version number of the live streaming terminal and the version number of the client are determined first. Whether the main version numbers of both are consistent is then determined: if yes, it is considered that the two are functionally compatible, and the subsequent connection flow can be carried out; and if no, the prompt information is output immediately to inform the user of the version incompatibility problem and recommend upgrading to the compatible version.

For the compliance problem, the live streaming control software follows a standardized country code convention, ensuring that the live streaming terminal and the client can run only under the same country code and avoiding violating the laws and regulations of a country or a region.

Before establishing the connection, the live streaming terminal and the client may verify the country codes submitted by the opposite parties. The connection flow is allowed to continue only when the country codes of both parties are completely consistent. If not matching, the prompt information is output to inform the user of the country code inconformity problem and to prevent connection establishment to avoid the compliance risks.

The live streaming room number is a key identifier for establishing the connection between the live streaming terminal and the client. In the live streaming process, the live streaming terminal may push the live streaming content to the client of the specific live streaming room number. Therefore, ensuring that the live streaming room numbers corresponding to the live streaming terminal and the client match is the premise of establishing an effective connection.

When an attempt is made to establish a connection, the live streaming terminal and the client may confirm the live streaming room numbers of the opposite parties. The connection establishment is allowed only when the room numbers submitted by both parties are completely consistent. If not matching, the prompt information is output to inform the user of possibly connecting to a wrong room and recommend to reattempt to connect after checking the room number.

For example, in order to facilitate verification of the compatibility problem by the live streaming terminal and the client of the live streaming control software so as to prompt the user in time when the incompatibility problem occurs, the target media server may provide a third service interface. For example, the third service interface is a web service interface, which may be denoted as query Rooms ( ) By means of the third service interface, the live streaming terminal and the client may query the room information that has been established on the target media server, including the live streaming room number of each room, the country code, and the version number.

For example, as shown in FIG. 4, two rooms A and B are created in the target media server. The live streaming terminal or clients (a first client and a second client) may send query requests to the target media server by invoking the query Rooms ( ) interface. For example, the live streaming terminal may acquire the corresponding live streaming room number, country code and version number locally from the live streaming terminal itself. Then, the query request sent by the live streaming terminal is used for querying the live streaming room number, the country code and the version number of the client that accesses the target media server. For example, the client may acquire the corresponding live streaming room number, country code and version number locally from the client itself. Then, the query request sent by the first client (or the second client) is used for querying the live streaming room number, the country code and the version number of the live streaming terminal that accesses the target media server.

The target media server may respond to the query requests and return a corresponding third response message. Both the live streaming terminal and the client verify whether the live streaming terminal and the client meet the matching requirement of the live streaming room number, the country code and the version number according to the returned third response message.

If a verification result shows not matching, the live streaming terminal or the client may output corresponding prompt information according to the specific reason for not matching. Such prompt information is helpful for the user to rapidly locate the problem and take the corresponding solution.

In response to that the live streaming room numbers respectively corresponding to the live streaming terminal and the client match with each other, the country codes respectively corresponding to the live streaming terminal and the client match with each other, and the version numbers respectively corresponding to the live streaming terminal and the client match with each other, the target media server allows the client to enter the specified room to establish a connection with the live streaming room, and the live streaming room pushes the live streaming content to the client that connects to the live streaming room number by using the target media server.

By designing and implementing the above-mentioned mechanisms, the live streaming system for a local area network can effectively ensure the compatibility and the compliance of connection between the live streaming terminal and the client, enhance the user experience, reduce the compliance risks, and provide strong guarantee for smooth transmission of the live streaming content.

All the technical solutions described above can be arbitrarily combined to form optional embodiments of the present application, which are not described one by one herein.

The embodiments of the present application are applied to the live streaming system for a local area network. The live streaming system for a local area network includes the live streaming terminal, the target media server and the client that access the local area network. The live streaming terminal accesses the local area network: the live streaming terminal determines the target media server that accesses the local area network based on the multicast protocol mechanism or the address resolution protocol scanning mechanism: the live streaming room number of the target media server is obtained; and the live streaming terminal pushes, by using the target media server, the live streaming content to the client that connects to the live streaming room number. The embodiments of the present application introduce the multicast protocol (e.g., mDNS) or the address resolution protocol (ARP) scanning mechanism, so that the live streaming terminal can automatically discover and identify the target media server within the local area network. The double mechanisms not only make the discovery of the target media server more intelligent and automatic, but also greatly increase the discovery probability of the target media server in a complex network environment. Such a design of double mechanisms enables the system to adapt to more types of network environments. The target media server can be found through a suitable mechanism even in an environment where the network multicast function is limited, and then a live streaming connection is established. The process of automatically discovering and connecting the target media server greatly simplifies the deployment flow of the live streaming system for a local area network, thereby improving the deployment efficiency. Meanwhile, because the system can establish the live streaming connection more stably, the problems of stream interruption, lags and the like in the live streaming process are effectively mitigated, and the stability of live streaming and the user experience are further improved.

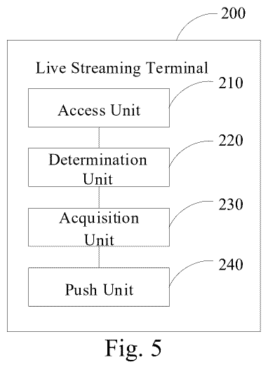

In order to better implement the live streaming method for a local area network of the embodiments of the present application, an embodiment of the present application further provides a live streaming terminal. With reference to FIG. 5, FIG. 5 is a structural schematic diagram of a live streaming terminal provided by an embodiment of the present application. The live streaming terminal 200 is applied to a live streaming system for a local area network live streaming, and the live streaming system for a local area network includes a live streaming terminal, a target media server and a client that access the local area network. The live streaming terminal 200 may include:
an access unit 210, configured to access a local area network;
a determination unit 220, configured to determine a target media server that accesses the local area network based on a multicast protocol mechanism or an address resolution protocol scanning mechanism;
an acquiring unit 230, configured to acquire a live streaming room number of the target media server; and
a pushing unit 240, configured to push a live streaming content to a client connecting to the target media server by using the target media server.

In some embodiments, the determination unit 220 may be configured to:
detect whether the local area network supports the multicast protocol mechanism;
in response to that the local area network supports the multicast protocol mechanism, determine the target media server accessing the local area network based on the multicast protocol mechanism; or
in response to that the local area network does not support the multicast protocol mechanism, determine the target media server accessing the local area network based on the address resolution protocol scanning mechanism.

In some embodiments, the determination unit 220, when detecting whether the local area network supports the multicast protocol mechanism, may be configured to:
in a test time window, send a test data package to a target multicast address and a target port number within the local area network at a preset frequency:
in response to that a response data package corresponding to the test data is received before the test time window ends, determine that the local area network supports the multicast protocol mechanism; or
in response to that no response data package corresponding to the test data is received after the test time window ends, determine that the local area network does not support the multicast protocol mechanism.

In some embodiments, the determination unit 220, when determining the target media server that accesses the local area network based on the multicast protocol mechanism, may be configured to:
send a multicast query message to the local area network;
receive a first response message corresponding to the multicast query message, wherein the first response message includes identification information of the target media server; and
determine the target media server that accesses the local area network based on the first response message.

In some embodiments, the identification information includes an internet protocol (IP) address; and the determination unit 220, when determining the target media server that accesses the local area network based on the first response message, may be configured to:
determine the target media server that accesses the local area network based on an IP address of the target media server carried by the first response message.

In some embodiments, the first response message further includes a live streaming room number of the target media server: the live streaming room number is generated based on identification information of the target media server; and

The acquiring unit 230 may be configured to:
acquire the live streaming room number of the target media server based on the live streaming room number of the target media server carried by the first response message.

In some embodiments, the determination unit 220, when determining the target media server that accesses the local area network based on the address resolution protocol scanning mechanism, may be configured to:
determine an active media server based on the address resolution protocol scanning mechanism;
send a state query message to the active media server; and
receive a second response message fed back by the active media server in response to the state query message, and determine the target media server.

In some embodiments, the determination unit 220, when determining the active media server based on the address resolution protocol scanning mechanism, may be configured to:
send a scanning request that contains a target address range into the local area network, so as to request to scan media access control (MAC) addresses of all active media servers within the target address range; and
determine IP addresses of all the active media servers within the local area network according to the received MAC addresses fed back from the active media servers within the local area network in response to the scanning request.

In some embodiments, the determination unit 220, when sending the state query message to the active media server, may be configured to: send the state query message to a first service interface of each of the active media servers based on the IP address of each of the active media servers, wherein the first service interface is configured to query a working state of the media server.

In some embodiments, the determination unit 220, when receiving the second response message fed back by the active media server in response to the state query message and determining the target media server, may be configured to:
parse a content of the second response message, and determine a media server as a candidate media server, wherein the media server, in response to the state query message, determines the working state as a normal working state based on the second response message:
parse the content of the second response message to determine whether the live streaming terminal, the candidate media server and the client match; and
in response to that the live streaming terminal, the candidate media server and the client match, determine the candidate media server as the target media server.

In some embodiments, the second response message further includes a live streaming room number of the target media server: the live streaming room number is generated based on the identification information of the target media server; and
the acquiring unit 230 may be configured to: acquire the live streaming room number of the target media server based on the live streaming room number of the target media server carried by the second response message.

In some embodiments, the identification information further includes a MAC address; and the live streaming room number is generated by an information digest encryption algorithm based on the MAC address of the target media server.

In some embodiments, the determination unit 220 may be further configured to:
detect whether a plurality of media servers are present within the local area network;
in response to detecting that a plurality of media servers are present within the local area network, determine one of the media servers as the target media server; and
by using a second server interface, control other media servers to be turned off, or control other media servers to enter a sleep state.

In some embodiments, the determination unit 220 is configured to:
in response to detecting that no media server is present within the local area network, determine, by the live streaming terminal, the target media server that accesses the local area network based on the multicast protocol mechanism or the address resolution protocol scanning mechanism.

In some embodiments, the pushing unit 240, before the live streaming terminal pushes the live streaming content to the client connecting to the live streaming room number by using the target media server, may be further configured to:
acquire a live streaming room number, a country code and a version number corresponding to the live streaming terminal;
acquire a live streaming room number, a country code and a version number corresponding to the client; and
in response to the live streaming room numbers respectively corresponding to the live streaming terminal and the client match with each other, the country codes respectively corresponding to the live streaming terminal and the client match with each other, and the version numbers respectively corresponding to the live streaming terminal and the client match with each other, push, by the live streaming terminal, the live streaming content to the client connecting to the live streaming room number by using the target media server.

It is noted that for the functions of the units in the live streaming terminal 200 in the embodiments of the present application, corresponding references may be made to the specific implementation of any of the above method embodiments, which will not be described redundantly here.

The units in the live streaming terminal 200 described above may be implemented in whole or in part by software, hardware, or a combination thereof. The above-mentioned units may be embedded in or independent of a processor of a computer device in the form of hardware, or stored in a memory of the computer device in the form of software, such that the processor calls and performs corresponding operations of the units.

In some embodiments, the present application further provides a computer-readable storage medium for storing a computer program. The computer-readable storage medium may be applied to a terminal device or a server, and the computer program causes the terminal device or the server to perform the corresponding flows of the live streaming method for a local area network in the embodiments of the present application, which will not be described redundantly here for brevity.

In some embodiments, the present application further provides a computer program product, including a computer program stored in a computer-readable storage medium. A processor of a computer device reads the computer program from the computer-readable storage medium. The processor executes the computer program such that the computer device to perform the corresponding flows of the live streaming method for a local area network in the embodiments of the present application, which will not be described redundantly here for brevity.

The present application further provides a computer device, including a memory having a computer program stored thereon, and a processor configured to execute the computer program in the memory to implement the live streaming method for a local area network in the embodiments of the present application, which will not be described redundantly here for brevity.

It should be appreciated that the processor in the embodiments of the present application may be an integrated circuit chip capable of signal processing. During the implementation, the steps of each method may be performed by using an integrated logic circuit of hardware in a processor or by using instructions in a form of software. The processor may be a general-purpose processor, a digital signal processor (DSP), an application-specific integrated circuit (ASIC), a field-programmable gate array (FPGA), or other programmable logic device, a discrete gate or transistor logic device, or a discrete hardware component. The processor can implement or perform the methods, steps and logical block diagrams disclosed in the embodiments of the present application. The general-purpose processor may be a microprocessor, or the processor may be any conventional processor, etc. The steps of the methods disclosed with reference to the embodiments of the present application may be directly performed by a hardware decoding processor, or performed by a combination of hardware and software modules in the decoding processor. The software module may be located in a mature storage medium in the art, such as a random access memory, a flash memory, a read-only memory, a programmable read-only memory, an electrically erasable programmable memory, or a register. The storage medium is located in a memory. The processor reads information in the memory, and completes the steps of the above-described method in combination with hardware in the processor.

It can be understood that the memory in the embodiments of the present application may be a volatile memory or a non-volatile memory, or may include both a volatile memory and a non-volatile memory. The non-volatile memory may be ready-only memory (ROM), a programmable ROM (PROM), an erasable PROM (EPROM), an electrically EPROM (EEPROM), or a flash memory. The volatile memory may be a random access memory (RAM), which is used as an external cache. Through illustrative rather than restrictive description, RAMs of many forms are available, for example, a static RAM (SRAM), a dynamic RAM (DRAM), a synchronous DRAM (SDRAM), a double data rate SDRAM (DDR SDRAM), an enhanced SDRAM (ESDRAM), synchlink DRAM (SLDRAM), and a direct rambus RAM (DRRAM). It should be noted that the memory involved in the systems and methods described in this specification is intended to include, but is not limited to, these memories and a memory of any other suitable type.

Those of ordinary skill in the art may be aware that units and algorithm steps in examples described with reference to the embodiments disclosed in this specification can be implemented by electronic hardware or a combination of computer software and electronic hardware. Whether these functions are implemented by using hardware or software depends on the specific application of the technical solutions and design constraints. A person skilled in the art may use different methods to implement the described functions for each specific application, but such an implementation should not be considered to be beyond the scope of the present application.

A person skilled in the art can clearly understand that for convenience and brevity of description, references may be made to corresponding processes in the foregoing method embodiments for specific working processes of the foregoing systems, apparatuses, and units. Details are not described herein again.

In several embodiments provided in the present application, it should be understood that the disclosed systems, apparatuses, and methods may be implemented in other manners. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electrical, mechanical, or other forms.

The units described as separate parts may or may not be physically separate. Parts shown as units may or may not be physical units, which may be located in one position, or may be distributed on a plurality of network units. Some or all of the units may be selected according to actual requirements to achieve the objectives of the solutions of the embodiments.

In addition, functional units in the embodiment of the present application may be integrated into one processing unit, or each of the units may exist alone physically, or two or more units are integrated into one unit.

If implemented in a form of a software functional unit and sold or used as a stand-alone product, functions may be stored in a computer-readable storage medium. Based on such an understanding, the technical solutions of the present application essentially, or a part contributing to the prior art, or some of the technical solutions may be embodied in a form of a software product. The computer software product is stored on a storage medium, and includes several instructions to enable a computer device (which may be a personal computer, or a server) to execute all or some steps of the methods according to the embodiments of the present application. The storage mediums described previously include various mediums that can store a program code, such as a USB flash disk, a mobile hard disk, a read-only memory (ROM), a random access memory (RAM), a magnetic disk, or an optical disk.

The foregoing descriptions are merely specific implementations of the present application, but the protection scope of the present application is not limited thereto. Any variation or replacement readily figured out by a person skilled in the art within the technical scope disclosed in the present application shall fall within the protection scope of the present application. Therefore, the protection scope of the present application should be subject to the protection scope of the claims.

1. A live streaming method for a local area network, wherein the live streaming method is applied to a live streaming system for a local area network, the live streaming system for a local area network comprises a live streaming terminal, a target media server and a client that access the local area network; wherein the method comprises:
a live streaming terminal accessing a local area network;
determining, by the live streaming terminal, a target media server that accesses the local area network based on a multicast protocol mechanism or an address resolution protocol scanning mechanism;
acquiring, by the live streaming terminal, a live streaming room number of the target media server; and
pushing, by the live streaming terminal, a live streaming content to a client connecting to the live streaming room number by using the target media server.

2. The live streaming method for a local area network according to claim 1, wherein the determining, by the live streaming terminal, a target media server that accesses the local area network based on a multicast protocol mechanism or an address resolution protocol scanning mechanism comprises:
detecting whether the local area network supports the multicast protocol mechanism;
in response to that the local area network supports the multicast protocol mechanism, determining, by the live streaming terminal, the target media server that accesses the local area network based on the multicast protocol mechanism; or
in response to that the local area network does not support the multicast protocol mechanism, determining, by the live streaming terminal, the target media server that accesses the local area network based on the address resolution protocol scanning mechanism.

3. The live streaming method for a local area network according to claim 2, wherein the detecting whether the local area network supports the multicast protocol mechanism comprises:
in a test time window, sending a test data package to a target multicast address and a target port number within the local area network at a preset frequency;
in response to that a response data package corresponding to the test data is received before the test time window ends, determining that the local area network supports the multicast protocol mechanism; or
in response to that no response data package corresponding to the test data is received after the test time window ends, determining that the local area network does not support the multicast protocol mechanism.

4. The live streaming method for a local area network according to claim 2, wherein the determining, by the live streaming terminal, the target media server that accesses the local area network based on the multicast protocol mechanism comprises:
sending, by the live streaming terminal, a multicast query message to the local area network;
receiving, by the live streaming terminal, a first response message corresponding to the multicast query message, wherein the first response message comprises identification information of the target media server; and
determining the target media server that accesses the local area network based on the first response message.

5. The live streaming method for a local area network according to claim 4, wherein the identification information comprises an internet protocol (IP) address; and the determining the target media server that accesses the local area network based on the first response message comprises:
determining the target media server that accesses the local area network based on the IP address of the target media server carried by the first response message.

6. The live streaming method for a local area network according to claim 4, wherein the first response message further comprises a live streaming room number of the target media server; the live streaming room number is generated based on the identification information of the target media server; and
the acquiring, by the live streaming terminal, a live streaming room number of the target media server comprises:
acquiring, by the live streaming terminal, the live streaming room number of the target media server based on the live streaming room number of the target media server carried by the first response message.

7. The live streaming method for a local area network according to claim 6, wherein the identification information further comprises a media access control (MAC) address; and the live streaming room number is generated by an information digest encryption algorithm based on the MAC address of the target media server.

8. The live streaming method for a local area network according to claim 2, wherein the determining, by the live streaming terminal, the target media server that accesses the local area network based on the address resolution protocol scanning mechanism comprises:
determining, by the live streaming terminal, an active media server based on the address resolution protocol scanning mechanism;
sending, by the live streaming terminal, a state query message to the active media server; and
receiving, by the live streaming terminal, a second response message fed back by the active media server in response to the state query message, and determining the target media server.

9. The live streaming method for a local area network according to claim 8, wherein the determining, by the live streaming terminal, an active media server based on the address resolution protocol scanning mechanism comprises:
sending, by the live streaming terminal, a scanning request that contains a target address range into the local area network, so as to request to scan media access control (MAC) addresses of all active media servers within the target address range; and
determining IP addresses of all the active media servers within the local area network according to the received MAC addresses fed back from the active media servers within the local area network in response to the scanning request.

10. The live streaming method for a local area network according to claim 9, wherein the sending, by the live streaming terminal, a state query message to the active media server comprises:
sending, by the live streaming terminal, the state query message to a first service interface of each of the active media servers based on the IP address of each of the active media servers, wherein the first service interface is configured to query a working state of the media server.

11. The live streaming method for a local area network according to claim 10, wherein the receiving, by the live streaming terminal, a second response message fed back by the active media server in response to the state query message, and determining the target media server comprise:
parsing, by the live streaming terminal, a content of the second response message, and determining a media server as a candidate media server, wherein the media server, in response to the state query message, determines the working state as a normal working state based on the second response message;
parsing, by the live streaming terminal, the content of the second response message to determine whether the live streaming terminal, the candidate media server and the client match; and
in response to that the live streaming terminal, the candidate media server and the client match, determining the candidate media server as the target media server.

12. The live streaming method for a local area network according to claim 8, wherein the second response message further comprises a live streaming room number of the target media server; the live streaming room number is generated based on the identification information of the target media server; and
the acquiring, by the live streaming terminal, a live streaming room number of the target media server comprises:
acquiring, by the live streaming terminal, the live streaming room number of the target media server based on the live streaming room number of the target media server carried by the second response message.

13. The live streaming method for a local area network according to claim 11, wherein the identification information further comprises a MAC address; and the live streaming room number is generated by an information digest encryption algorithm based on the MAC address of the target media server.

14. The live streaming method for a local area network according to claim 1, wherein after the live streaming terminal accessing a local area network, the method further comprises:
detecting whether a plurality of media servers are present within the local area network;
in response to detecting that the plurality of media servers are present within the local area network, determining one of the plurality of media servers as the target media server; and
by using a second server interface, controlling other media servers to be turned off, or controlling other media servers to enter a sleep state.

15. The live streaming method for a local area network according to claim 14, further comprising:
in response to detecting that no media server is present within the local area network, determining, by the live streaming terminal, the target media server that accesses the local area network based on the multicast protocol mechanism or the address resolution protocol scanning mechanism.

16. The live streaming method for a local area network according to claim 1, before the pushing, by the live streaming terminal, a live streaming content to a client connecting to the live streaming room number by using the target media server, the method further comprises:
acquiring a live streaming room number, a country code and a version number corresponding to the live streaming terminal;
acquiring a live streaming room number, a country code and a version number corresponding to the client; and
in response to that the live streaming room numbers respectively corresponding to the live streaming terminal and the client match with each other, the country codes respectively corresponding to the live streaming terminal and the client match with each other, and the version numbers respectively corresponding to the live streaming terminal and the client match with each other, pushing, by the live streaming terminal, the live streaming content to the client connecting to the live streaming room number by using the target media server.

17. The live streaming method for a local area network according to claim 2, wherein after the live streaming terminal accessing a local area network, the method further comprises:
detecting whether a plurality of media servers are present within the local area network;
in response to detecting that the plurality of media servers are present within the local area network, determining one of the plurality of media servers as the target media server; and
by using a second server interface, controlling other media servers to be turned off, or controlling other media servers to enter a sleep state.

18. The live streaming method for a local area network according to claim 2, before the pushing, by the live streaming terminal, a live streaming content to a client connecting to the live streaming room number by using the target media server, the method further comprises:
acquiring a live streaming room number, a country code and a version number corresponding to the live streaming terminal;
acquiring a live streaming room number, a country code and a version number corresponding to the client; and
in response to that the live streaming room numbers respectively corresponding to the live streaming terminal and the client match with each other, the country codes respectively corresponding to the live streaming terminal and the client match with each other, and the version numbers respectively corresponding to the live streaming terminal and the client match with each other, pushing, by the live streaming terminal, the live streaming content to the client connecting to the live streaming room number by using the target media server.

19. A non-transitory computer-readable storage medium, storing a computer program adapted to be loaded by a processor to perform a live streaming method for a local area network, wherein the live streaming method is applied to a live streaming system for a local area network, the live streaming system for a local area network comprises a live streaming terminal, a target media server and a client that access the local area network;
wherein the method comprises:
a live streaming terminal accessing a local area network;
determining, by the live streaming terminal, a target media server that accesses the local area network based on a multicast protocol mechanism or an address resolution protocol scanning mechanism;
acquiring, by the live streaming terminal, a live streaming room number of the target media server; and
pushing, by the live streaming terminal, a live streaming content to a client connecting to the live streaming room number by using the target media server.

20. A computer device, comprising:
a memory, having a computer program stored thereon, and
a processor, configured to execute the computer program in the memory to implement a live streaming method for a local area network, the live streaming system for a local area network comprises a live streaming terminal, a target media server and a client that access the local area network;
wherein the method comprises:
a live streaming terminal accessing a local area network;
determining, by the live streaming terminal, a target media server that accesses the local area network based on a multicast protocol mechanism or an address resolution protocol scanning mechanism;
acquiring, by the live streaming terminal, a live streaming room number of the target media server; and
pushing, by the live streaming terminal, a live streaming content to a client connecting to the live streaming room number by using the target media server.
